(19) United States
(12) Patent Application Publication
(10) Pub. No.: US 2006/0067873 A1
(43) Pub. Date: Mar. 30, 2006

(54) Process for the production of chlorine dioxide

(75) Inventor: Maria Kristina Johansson, Stockholm (SE)

Correspondence Address: WHITE, REDWAY & BROWN LLP, 1217 KING STREET, ALEXANDRIA, VA, 22314, US

(73) Assignee: Akzo Nobel N.V., SB Arnhem (NL)

(21) Appl. No.: 11/228,475

(22) Filed: Sep. 19, 2005

Related U.S. Application Data
(60) Provisional application No. 60/612,643, filed on Sep. 24, 2004.

(51) Int. Cl. C01B 11/02

(52) U.S. Cl. 423/478

(57) ABSTRACT

The invention relates to a process for the continuous production of chlorine dioxide under non-crystallising conditions in at least two reaction vessels comprising the steps of feeding to a first reaction vessel alkali metal chlorate, a mineral acid and hydrogen peroxide to form an acidic reaction medium maintained in said first reaction vessel, reacting alkali metal chlorate, hydrogen peroxide and mineral acid in said reaction medium to form chlorine dioxide and alkali metal salt of the mineral acid, withdrawing chlorine dioxide from said reaction medium in said first reaction vessel as a gas, withdrawing depleted reaction medium comprising mineral acid, alkali metal chlorate and alkali metal salt of the mineral acid from said first reaction vessel and feeding it to a second reaction vessel, feeding hydrogen peroxide to the reaction medium in said second reaction vessel and maintaining said reaction medium therein at a concentration of alkali metal chlorate from about 9 to about 75 mmoles/litre, reacting alkali metal chlorate, hydrogen peroxide and mineral acid in said reaction medium to form chlorine dioxide and alkali metal salt of the mineral acid, withdrawing chlorine dioxide from said reaction medium in said second reaction vessel as a gas, and withdrawing depleted reaction medium comprising mineral acid and alkali metal salt of the mineral acid from said second reaction vessel.

The present invention relates to a process for the continuous production of chlorine dioxide under non-crystallising conditions in at least two reaction vessels.

Chlorine dioxide used in aqueous solution is of considerable commercial interest, mainly in pulp bleaching, but also in water purification, fat bleaching, removal of phenols from industrial wastes etc. It is therefore desirable to provide processes in which chlorine dioxide can be efficiently produced.

There are numerous different processes for chlorine dioxide production. Most large scale processes in commercial use involve continuous reaction of alkali metal chlorate in an acidic reaction medium with a reducing agent such as hydrogen peroxide, methanol, chloride ions or sulfur dioxide to form chlorine dioxide that is withdrawn as a gas from the reaction medium. Generally, the acidity is mainly provided by addition of sulfuric acid and the sulfate is withdrawn as a by-product in the form of solid alkali metal sulfate or dissolved in depleted reaction medium.

In one kind of processes the reaction medium is maintained in a single reaction vessel under boiling conditions at subatmospheric pressure, wherein alkali metal salt of the acid is precipitated and withdrawn as a salt cake. Such processes are described in e.g. U.S. Pat. Nos. 5,770,171, 5,091,166 and 5,091,167.

In another kind of processes the reaction medium is maintained under non-crystallising conditions, generally at substantially atmospheric pressure. In most cases depleted reaction medium from a first reaction vessel is brought to a second reaction vessel for further reactions to produce chlorine dioxide. Early examples of such processes are the Mathieson and Solvay processes using sulfur dioxide and methanol, respectively, as reducing agents. Attempts to modernise these processes by at least partly using hydrogen peroxide as reducing agent are described in e.g. JP Laid Open Applications, Laid Open No. 1988-008203, 1991-115102 and WO 01/077012 but have been commercialised only to a very limited extent. A break-through came with the process disclosed in EP 612686 using hydrogen peroxide as reducing agent in both the first and the second reaction vessels. Such a process has been commercialised under the trademark HP-A® and is easy to operate and enables high capacity production of chlorine dioxide with high yield in simple equipment.

In the non-crystallising processes depleted reaction medium withdrawn from the final reaction vessel contains acid, alkali metal salt of the acid and unreacted alkali metal chlorate which thus is lost. It has then been believed that the process should be operated with as low chlorate concentration as possible in the final (normally the second) reaction vessel to minimise the losses. On the other hand, it has been found that if the chlorate concentration is too low, the corrosion of the process equipment (generally at least partly made of titanium) increases. However, it has now surprisingly been found that in a process using hydrogen peroxide as reducing agent it is possible to operate with a higher chlorate concentration than previously believed without significantly increasing the loss of chlorate.

The invention thus concerns a process for the continuous production of chlorine dioxide under non-crystallising conditions in at least two reaction vessels comprising the steps of feeding to a first reaction vessel alkali metal chlorate, a mineral acid and hydrogen peroxide to form an acidic reaction medium maintained in said first reaction vessel, reacting alkali metal chlorate, hydrogen peroxide and mineral acid in said reaction medium to form chlorine dioxide and alkali metal salt of the mineral acid, withdrawing chlorine dioxide from said reaction medium in said first reaction vessel as a gas, withdrawing depleted reaction medium comprising mineral acid, alkali metal chlorate and alkali metal salt of the mineral acid from said first reaction vessel and feeding it to a second reaction vessel, feeding hydrogen peroxide to the reaction medium in said second reaction vessel and maintaining said reaction medium therein at a concentration of alkali metal chlorate from about 9 to about 75 mmoles/litre, preferably from about 14 to about 56 mmoles/litre, most preferably 20 to about 47 mmoles/litre, reacting alkali metal chlorate, hydrogen peroxide and mineral acid in said reaction medium to form chlorine dioxide and alkali metal salt of the mineral acid, withdrawing chlorine dioxide from said reaction medium in said second reaction vessel as a gas, and withdrawing depleted reaction medium comprising mineral acid and alkali metal salt of the mineral acid from said second reaction vessel.

The reactions taking place in the reaction vessels are complex and not fully known in every detail. The main products are chlorine dioxide, oxygen and alkali metal salt of the mineral acid. Under certain circumstances some of the chlorate is converted to chloride as end product instead of chlorine dioxide. It was found that the amount of chloride obtained as end product could be lowered by increasing the chlorate concentration in the second reaction vessel. Thus, the lower amount of chloride in the depleted reaction medium withdrawn from the second reaction vessel to a great extent compensates for the loss through the higher chlorate concentration.

Preferably inert gas is blown through the reaction vessels to increase the agitation and dilute the chlorine dioxide to a safe concentration. It is also possible to introduce some inert gas above the liquid level in the reaction vessels. Any available inert gas such as nitrogen or oxygen can be used, but for cost reasons it is usually preferred to use air.

The chlorine dioxide and oxygen formed in the reaction vessels are withdrawn as a gas together with any inert gas blown through the vessels. The gas is preferably brought to an absorber where it is contacted with water to dissolve the chlorine dioxide while the main part of the oxygen and other non-soluble gases pass through. The chlorine dioxide water can then be collected in a storage tank and be used for any desired purpose such as bleaching of pulp.

The depleted reaction medium withdrawn from the second reaction vessel is preferably brought to a stripper fed with inert gas to blow off chlorine dioxide and other gaseous species still remaining therein. The gas from the stripper can then be brought to the absorber together with the gas from the reaction vessels. The stripped depleted reaction medium, also referred to as waste acid, may in many cases be used for pH adjustments and/or a source of sulfur in a pulping process. It is also possible to electrochemically increase its acidity it in a cell as described in, for example, U.S. Pat. Nos. 5,487,881 and 6,322,690, and optionally recycle it fully or partly to the first reaction vessel where it then constitutes at least part of the mineral acid feed.

Usually chlorate of sodium, potassium or a mixture thereof is used, but also other alkali metals may come into question. The alkali metal chlorate is usually fed in the form of an aqueous solution, preferably of high concentration, for example from about 3 moles/litre up saturation. In most cases it is not necessary to feed any chlorate to the second reaction vessel apart from what is contained in the depleted reaction medium from the first reaction vessel.

Alkali metal chlorate usually contains small amounts of chloride as an impurity, but it is preferred if this amount is as low as possible which decreases the formation of chlorine as a by-product. It is preferred that the amount of chloride in alkali metal chlorate feed is less than about 1 mole %, more preferably less than about 0.5 mole %, most preferably less than about 0.05 mole %, particularly most preferably less than about 0.02 mole %.

The mineral acid is preferably a halogen free acid such as sulfuric acid or phosphoric acid, of which sulfuric acid is most preferred, for example at a concentration from about 60 to about 98 wt % o. Also mixtures of mineral acids may come into question. In most cases it is not necessary to feed any mineral acid to the second reaction vessel apart from what is contained in the depleted reaction medium from the first reaction vessel.

It is preferred that substantially no chloride except the impurities in the alkali metal chlorate is fed to the process. However, small amounts of chloride may be present also in other feed streams, such as the mineral acid. Preferably the total amount of chloride fed to the process, including impurities in the alkali metal chlorate, is less than about 1 mole %, more preferably less than about 0.5 mole %, most preferably less than about 0.05 mole %, particularly most preferably less than about 0.02 mole % chloride of the alkali metal chlorate feed.

Hydrogen peroxide is used as reducing agent in both the first and the second reaction vessel and is usually fed as an aqueous solution, preferably with a concentration from about 10 to about 70 wt %, most preferably from about 25 to about 60 wt %. Preferably the amount of hydrogen peroxide fed is from about 0.5 to about 2 moles per mole alkali metal chlorate fed, most preferably from about 0.5 to about 1 mole per mole alkali metal chlorate fed, particularly most preferably from about 0.5 to about 0.6 moles per mole alkali metal chlorate fed. Preferably from about 50 to about 99.9%, most preferably from about 85 to about 99.5% of the total amount of hydrogen peroxide is fed to the first reaction vessel. Apart from the small amount of chloride present as an impurity in the chlorate hydrogen peroxide is preferably the only added reducing agent, although it is fully possible to also add other reducing agents such as methanol, formaldehyde, formic acid, sugar alcohols, sulfur dioxide and chloride. In the case of other reducing agents being added, the amount of hydrogen peroxide added may be lowered.

The reactants may be fed as separate or pre-mixed feed streams. Particularly it is possible to pre-mix hydrogen peroxide and alkali metal chlorate into a common feed stream, while it is preferred to feed the mineral acid separately.

The temperature of the reaction medium in the reactions vessels is preferably maintained from about 30 to about 100° C., most preferably from about 40 to about 80° C. The temperature may be substantially the same in the first and the second reaction vessels, but it is also possible to operate with different temperatures. Preferably the temperature of the reaction medium in the first and second reaction vessels is below the boiling point at the prevailing pressure. Depending on the ambient temperature, the temperature of the feed streams, the rate of inert gas blowing and other process conditions, it may be necessary to heat or cool the reaction vessels in order to maintain the desired temperature.

The absolute pressure maintained in the reaction vessels is preferably from about 50 to about 120 kPa, most preferably from about 80 to about 110 kPa, particularly most preferably at about atmospheric pressure. The pressure is usually but not necessarily substantially the same in the first and the second reaction vessels.

The acidity of the reaction medium in the first and the second vessels is preferably maintained from about 4 to about 14 N, most preferably from about 6 to about 12 N. In most cases there is only a minor difference in acidity between the first and second reaction vessels, preferably less than about 15%, most preferably less than about 10%.

The concentration of alkali metal chlorate in the reaction medium in the first reaction vessel is preferably maintained from about 0.05 to saturation, more preferably from about 0.075 to about 2.5 moles/litre, most preferably from about 0.1 to about 1 mole/litre.

In a preferred embodiment the reaction medium in the first reaction vessel is preferably maintained at an alkali metal chlorate concentration from about 0.05 to about 2.5 moles/litre, an acidity from about 6 to about 12 N, a temperature from about 40 to about 80° C. and an absolute pressure from about 80 to about 110 kPa, while the reaction medium in the second reaction vessel is preferably maintained at an alkali metal chlorate concentration from about 14 to about 56 mmoles/litre, an acidity from about 6 to about 12 N, a temperature from about 40 to about 80° C. and an absolute pressure from about 80 to about 110 kPa.

The same type of reaction vessels and other process equipment as in other non-crystallising processes (e.g. Mathieson, Solvay and HP-A®) can be used. Process equipment in contact with the reaction medium, including the reaction vessels, is suitably made from or lined with a material resistant to the chemicals therein. Preferred materials are titanium and other metals or alloys with capability of forming and maintaining a protective oxide layer in contact with the reaction medium, although part of the equipment may be made of other resistant materials such fluoro plastics or other polymeric materials. Preferably at least part of the equipment in contact with the reaction medium, including the second reaction vessel, is made of or lined with titanium.

The invention is further illustrated by means of the following example:

### EXAMPLE

Chlorine dioxide was continuously produced in a generator comprising a first reaction vessel (Primary reactor) and a second reaction vessel (Secondary reactor). Sodium chlorate (containing about 0.01 wt % sodium chloride as impurity), sulfuric acid and hydrogen peroxide were fed to the first reaction vessel. An overflow of reaction medium from the first reaction vessel was brought to the second reaction vessel to which also hydrogen peroxide was fed. An overflow of reaction medium from the second reaction vessel was withdrawn as waste acid after having passed a stripper. Air was blown through the reaction medium in both the reaction vessels diluting the chlorine dioxide gas withdrawn therefrom. Both the reaction vessels were maintained at atmospheric pressure and a temperature of 57° C. Data were collected at several occasions under steady state conditions. The results are shown in the table below:

| | | | | | | | | | | |
|---|---|---|---|---|---|---|---|---|---|---|
| Primary | NaClO₃ | 103.3 | 90.2 | 112.7 | 131.5 | 171.0 | 129.6 | 156.9 | 242.4 | 131.5 |
| Reactor | (mmol/l) | | | | | | | | | |
| Primary | Acidity | 10.0 | 9.7 | 9.7 | 9.8 | 9.7 | 9.6 | 9.3 | 9.5 | 9.8 |
| Reactor | (N) | | | | | | | | | |
| Secondary | NaClO₃ | 4.7 | 25.4 | 15.0 | 10.3 | 45.7 | 29.1 | 45.3 | 36.6 | 12.5 |
| Reactor | (mmol/l) | | | | | | | | | |
| Secondary | NaCl | 29.1 | 12.0 | 13.7 | 24.0 | 8.6 | 12.0 | 8.6 | 14.4 | 25.8 |
| Reactor | (mmol/l) | | | | | | | | | |
| Secondary | Acidity | 10.3 | 9.6 | 8.9 | 9.6 | 9.6 | 9.5 | 9.3 | 9.5 | 9.6 |
| Reactor | (N) | | | | | | | | | |

It appears that a decrease of the sodium chlorate concentration in the second reaction vessel leads to an increase in the sodium chloride concentration. Since this increase is the result of chlorate being converted to chloride as end product this also represent a loss through the waste acid. Thus, the loss of unconverted chlorate by increasing the concentration thereof in the secondary reaction vessel is at least partially compensated for by lower loss through chloride formation. Even if the total loss in some cases may be higher, it is still within acceptable levels considering the advantage of less corrosion of the process equipment.

1. A process for the continuous production of chlorine dioxide under non-crystallising conditions in at least two reaction vessels comprising the steps of feeding to a first reaction vessel alkali metal chlorate, a mineral acid and hydrogen peroxide to form an acidic reaction medium maintained in said first reaction vessel, reacting alkali metal chlorate, hydrogen peroxide and mineral acid in said reaction medium to form chlorine dioxide and alkali metal salt of the mineral acid, withdrawing chlorine dioxide from said reaction medium in said first reaction vessel as a gas, withdrawing depleted reaction medium comprising mineral acid, alkali metal chlorate and alkali metal salt of the mineral acid from said first reaction vessel and feeding it to a second reaction vessel, feeding hydrogen peroxide to the reaction medium in said second reaction vessel and maintaining said reaction medium therein at a concentration of alkali metal chlorate from about 9 to about 75 mmoles/litre, reacting alkali metal chlorate, hydrogen peroxide and mineral acid in said reaction medium to form chlorine dioxide and alkali metal salt of the mineral acid, withdrawing chlorine dioxide from said reaction medium in said second reaction vessel as a gas, and withdrawing depleted reaction medium comprising mineral acid and alkali metal salt of the mineral acid from said second reaction vessel.

2. A process as claimed in claim 1, wherein concentration of alkali metal chlorate in said second reaction vessel is maintained from about 14 to about 56 mmoles/litre.

3. A process as claimed in claim 2, wherein concentration of alkali metal chlorate in said second reaction vessel is maintained from about 20 to about 47 mmoles/litre.

4. A process as claimed in claim 1, wherein inert gas is blown through the reaction vessels.

5. A process as claimed in claim 1, wherein the total amount of chloride fed to the process is less than about 1 mole % of the alkali metal chlorate feed.

6. A process as claimed in claim 1, wherein temperature of the reaction medium in the first and second reaction vessels is below the boiling point at the prevailing pressure.

7. A process as claimed in claim 1, wherein the acidity of the reaction medium in the first and the second vessels is maintained from about 4 to about 14 N.

8. A process as claimed in claim 1, wherein the mineral acid is sulfuric acid.

9. A process as claimed in claim 1, wherein the reaction medium in the first reaction vessel is maintained at an alkali metal chlorate concentration from about 0.05 to about 2.5 moles/litre, an acidity from about 6 to about 12 N, a temperature from about 40 to about 80° C. and an absolute pressure from about 80 to about 110 kPa, while the reaction medium in the second reaction vessel is maintained at an alkali metal chlorate concentration from about 14 to about 56 mmoles/litre, an acidity from about 6 to about 12 N, a temperature from about 40 to about 80° C. and an absolute pressure from about 80 to about 110 kPa.

10. A process as claimed in claim 1, wherein at least part of the equipment in contact with the reaction medium is made of or lined with titanium.
